(19) United States
(12) Patent Application Publication
(10) Pub. No.: US 2010/0157766 A1
(43) Pub. Date: Jun. 24, 2010

(54) Predicting cartridge failure from cartridge memory data

(76) Inventors: Jody L. Gregg, Lake Elmo, MN (US); C. Thomas Jennings, Woodbury, MN (US); Kim R. Olson, Woodbury, MN (US)

Correspondence Address: Shumaker & Sieffert. P.A., 1625 Radio Drive, Suite 300, Woodbury, MN, 55125, US

(21) Appl. No.: 12/317,304

(22) Filed: Dec. 22, 2008

(51) Int. Cl. G11B 20/18

(52) U.S. Cl. 369/53.41; G9B/20.046

(57) ABSTRACT

Techniques are described for predicting data cartridge failure based on analysis of data retrieved from an associated cartridge memory chip. In one embodiment, a system includes a chip reader that retrieves data from a cartridge memory chip of a data cartridge, and a computing device that receives the data from the chip reader, analyzes the data, and generates information regarding a health status of the data cartridge based on the analysis. The analysis may be based on execution of an algorithm that is developed from a set of data, stored in a database, that identifies characteristics of data cartridges with a good health status and differentiates them from data cartridges with a bad health status.

### TECHNICAL FIELD

The invention relates to magnetic data storage media and, more particularly, to cartridge memory chips of linear tape-open data cartridges.

### BACKGROUND

Increases in the amount of data handled by computer systems have led to demands for data storage back-up devices that use magnetic tape. Magnetic tape media remains an economical medium for storing large amounts of data. For example, magnetic tape cartridges, or large spools of magnetic tape, are often used to back up large amounts of data for large computing centers. Magnetic tape cartridges also find application in the backup of data stored on smaller computers such as workstations, desktop, or laptop computers. In addition, magnetic tape media can be used for other types of data storage, e.g., unrelated to data backup.

Automated cartridge libraries provide access to vast amounts of electronic data by managing magnetic data tape cartridges. Automated cartridge libraries exist in all sizes, ranging from small library systems that provide access to twenty or fewer data cartridges, to larger library systems that provide access to thousands of data cartridges.

One type of data storage system includes a linear tape drive. Linear tape-open (LTO) data cartridges are representative of linear tape products. Conventional LTO cartridges include a cartridge memory (CM) chip that may be, for example, a radio-frequency identification (RFID) chip. The CM chip may be affixed to or within a housing of the tape cartridges. LTO drives typically include an RFID interface that enables the drive to read and/or write data to the CM chip of an LTO cartridge. LTO drives include a radio frequency interface to read and write data to the CM chip over radio frequency signals. The data on the CM chip indicates, for example, the last four drive mounts, recent performance data, and the amount of information stored on the cartridge. For example, each time a tape cartridge is loaded or unloaded from a drive, the library system may read the CM chip and store the read data in the database. Other types of linear tape cartridges with similar radio frequency chips include IBM 3592 data cartridges and Sun T10000 data cartridges. Future tape cartridges will likely use CM chips as well.

### SUMMARY

In general, techniques are described for predicting failure of a data cartridge or cartridge drive by analyzing data stored on cartridge memory chips. In one embodiment, an analysis module identifies specific characteristics of a data cartridge based on data retrieved from an associated cartridge memory (CM) chip. The analysis module then determines a health status of the data cartridge based on the characteristics. Certain sets of values for the characteristics may indicate that the health status of the data cartridge is good, while other values may indicate that the health status is bad or that the data cartridge is in need of further analysis itself.

In one embodiment, a computing device records data gathered from a plurality of CM chips associated with various data cartridges. An administrator may then configure the computing device to reflect a determination of a set of characteristics of the data of the CM chips that tend to identify a data cartridge as having a bad health status or that the data cartridge is in need of further analysis. The computing device may then distribute the set of characteristics to other devices that interact with data cartridges to identify health statuses of the data cartridges. In one embodiment, the computing device may further determine, when a set of data cartridges each have a bad health status after interacting with a particular cartridge drive, that the cartridge drive itself has a bad health status and that the data cartridges should instead have good health statuses.

In one embodiment, a system includes a chip reader that retrieves data from a cartridge memory chip of a data cartridge, and a computing device that receives the data from the chip reader, analyzes the data, and generates information regarding a health status of the data cartridge based on the analysis.

In another embodiment, a method includes retrieving data from a cartridge memory chip of a data cartridge, analyzing the data from the cartridge memory chip, and generating information regarding a health status of the data cartridge based on the analysis of the data.

In another embodiment, a system includes a database that stores entries based on data from a plurality of cartridge memory chips, wherein each of the cartridge memory chips is associated with a respective data cartridge, a server computer that stores the entries in the database, and a plurality of client computers that retrieve the data from the plurality of cartridge memory chips and send at least a portion of the retrieved data to the server computer, wherein the server computer forms the entries for the database from the data received from the client computers, and wherein the server computer analyzes the entries stored in the database and generates information regarding a health status of at least one of the data cartridges based on the analysis.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example system for determining a health status of linear tape-open (LTO) cartridge.

FIG. 2 is a block diagram illustrating a portion of an example embodiment of a cartridge memory (CM) chip.

FIG. 3 is a block diagram illustrating an example system that determines characteristics of data cartridges that have a bad health status.

FIG. 4 is a flowchart illustrating an example method for predicting failure of a data cartridge based on data stored on a CM chip of the data cartridge.

FIG. 5 is a flowchart illustrating an example method for analyzing data of a CM chip.

FIGS. 6A-6C are graphs illustrating example data collected from data cartridges of an example client and compared with industry average data.

FIG. 7 is a graph illustrating example data collected from data cartridges of a client that were used to identify a malfunctioning cartridge drive.

### DETAILED DESCRIPTION

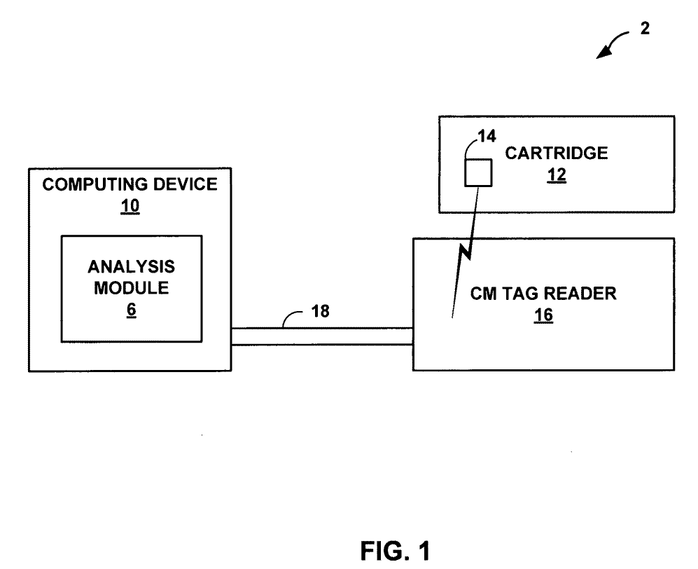

FIG. 1 is a block diagram illustrating an example system 2 for determining a health status of linear tape-open (LTO) cartridge 12. Although the example of FIG. 1 is described with respect to an LTO cartridge, the techniques discussed herein are applicable to other data cartridges as well, such as, for example, IBM 3592 data cartridges and Sun T10000 data cartridges. Generally, the techniques of this disclosure may apply to any data cartridges that include a cartridge memory (CM) chip.

In the example of FIG. 1, LTO cartridge 12 includes CM chip 14. In one embodiment, CM chip 14 is a radio frequency identification (RFID) tag that is adhered to or within a housing of cartridge 12. CM tag reader 16, in one embodiment, is capable of reading data from and writing data to CM chip 14. CM tag reader 16 may be capable of reading and writing data of CM chip 14 at a distance of, for example, 20 mm. In one embodiment, CM tag reader 16 may be a stand-alone tag-reading device. In another embodiment, CM tag reader 16 may be a cartridge drive designed to read data from and write data to cartridge 12. As one example, CM tag reader 16 may be a Baltech reader, commercially available from Baltech AG of Germany.

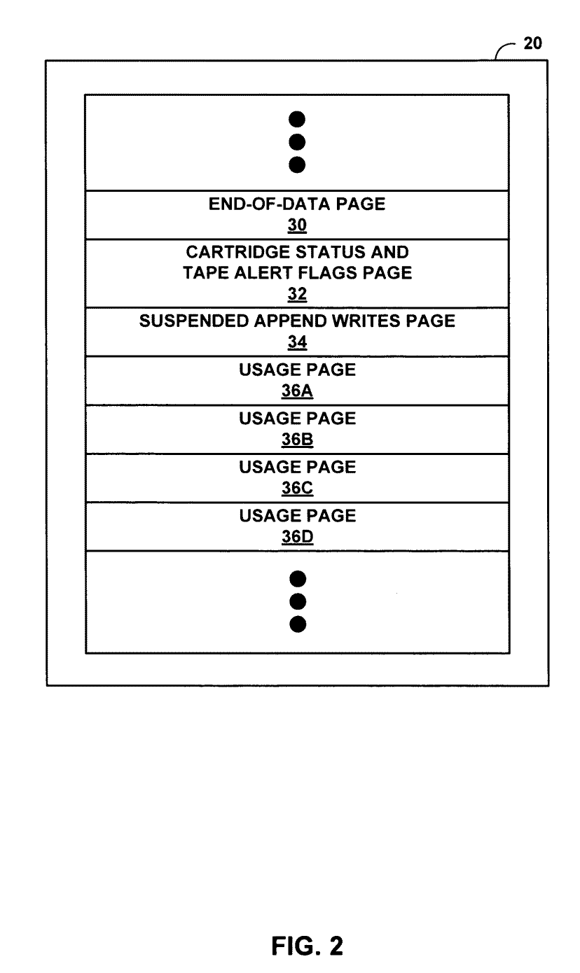

In one embodiment, CM chip 14 may be a chip conforming to the LTO-CM standard. LTO-CM chips are used to identify the cartridge and information about the cartridge. LTO-CM chips include a re-writeable section that includes initialization data when a format is initialized or reinitialized, usage information, a tape directory, EOD information, mechanism manufacturer information, and application specific data. LTO-CM chips are divided into 128 blocks of 32 bytes each, for a total storage capacity of 4096 bytes, in accordance with the LTO-CM standard. Where CM chip 14 conforms to the LTO-CM standard, the data of CM chip 14 is divided into pages. An end-of-data (EOD) page of CM chip 14 stores read- and write-error data regarding LTO cartridge 12, as discussed in greater detail with respect to FIG. 2.

In the example of FIG. 1, system 2 includes computing device 10 coupled to CM tag reader 16 via link 18. In one embodiment, link 18, between computing device 10 and CM tag reader 16, may include an RS232 interface. In another example embodiment, CM tag reader 16 may include one or more modules, either in hardware or in software, to perform the functions described with respect to computing device 10. In the example embodiment of FIG. 1, computing device 10 includes analysis module 6 to analyze the data received from CM tag reader 16. Computing device 10 controls CM tag reader 16 to obtain error data, such as read- and write-error data, from CM chip 14. In one embodiment, computing device 10 may be a stand-alone general purpose computer or workstation that executes software that facilitates interaction of computing device 10 with CM tag reader 16. Computing device 10 may also be a specialized computer designed solely to interact with CM tag reader 16. In general, computing device 10 may cause CM tag reader 16 to read data from and write data to CM chip 14 so that analysis module 6 may generate information regarding a health status of LTO cartridge 12 to predict failure of LTO cartridge 12 based on an analysis of data received from CM chip 14. For example, analysis module 6 may place a “suspect” data cartridge on a watch list for further analysis in the future. Analysis module 6 may also suggest replacing a data cartridge when the data cartridge is on a watch list. Analysis module 6 may also suggest replacing a data cartridge without the use of a watch list.

FIG. 2 is a block diagram illustrating a portion of an example embodiment of CM chip 20. In the example embodiment of FIG. 2, CM chip 20 conforms to the LTO-CM standard. In one embodiment, CM chip 20 corresponds to CM chip 14 of FIG. 1. CM chip 20 includes a number of pages that store data regarding a data cartridge associated with CM chip 20. In the example of FIG. 2, CM chip 20 includes EOD page 30, cartridge status and tape alert flags page 32, suspended append writes page 34, and four usage pages 36A-36D (usage pages 36). CM chip 20 also includes other pages in conformance with the LTO-CM standard that are not shown in FIG. 2.

An analysis module, such as analysis module 6, may analyze data retrieved from CM chip 20 to identify characteristics that tend to indicate that the associated data cartridge has a good health status or a bad health status. In the example of FIG. 2, these characteristics include whether an EOD page is valid, whether certain errors have exceeded a threshold, whether a write to the data cartridge has occurred recently, and whether an error count is increasing for the data cartridge. When analysis module 6 identifies certain combinations of these characteristics, analysis module 6 determines that the data cartridge has a poor health status. Consequently, analysis module 6 may place an identifier of the data cartridge on a watch list, recommend service or replacement of the data cartridge, recommend further analysis for the data cartridge, or provide other feedback to a user, such as an administrator or other user, regarding the analyzed data cartridge. For example, analysis module 6 may provide feedback through a user interface or send a message to another computing device through a computer network.

Usage pages 36 store data corresponding to the last four mounts, respectively, of the data cartridge associated with CM chip 20. In one embodiment, usage page 36A stores usage data corresponding to the most recent mount, usage page 36B stores usage data corresponding to the next most recent mount before 36A, usage page 36C stores usage data corresponding to the next most recent mount before 36B, and usage page 36D stores usage data corresponding to the next most recent mount before 36C. Usage pages 36A-36D may act as a first-in, first-out (FIFO) queue. In another embodiment, the one of usage pages 36 that represents the oldest mount of the data cartridge is overwritten and the ordering of usage pages 36 is determined from a thread count value of each of usage pages 36, which is equivalent to a thread count stored in cartridge status and tape alert flags 32, in accordance with the LTO-CM standard. The thread count of a particular one of usage pages 36 generally reflects a number of times that the data cartridge has been mounted. Therefore, a higher thread count indicates a more-recent mount than a lower thread count.

Each of usage pages 36 stores data regarding a particular mount of the associated data cartridge. For example, each of usage pages 36 may store values that reflect a total number of unrecovered write errors, a total number of unrecovered read errors, and a total number of fatal suspended writes, among other stored values. Analysis module 6 may utilize any or all of these numbers of errors as a characteristic for analysis. Unrecovered write errors occur when a write, e.g., a backup of data, to a data cartridge must be terminated. Unrecovered read errors occur when a data set of the data cartridge cannot be read on a first attempt nor on a subsequent attempt to read the data set. Fatal suspended write errors occur when a cartridge drive is unable to write data to a particular portion of the data cartridge and when the cartridge drive is unable to write the data further down the data cartridge. An analysis module, such as analysis module 6, may determine that a data cartridge has a bad health status when one of these values exceeds a corresponding threshold. For example, the thresholds for unrecovered read errors and unrecovered write errors may be equal to 10. As another example, the threshold for fatal suspended write errors may be equal to 1. Analysis module 6 may adjust the thresholds based on a manufacturer of LTO cartridge 12.

EOD page 30 contains 64 bytes of information, including an EOD validity identifier. Analysis module 6 may utilize data from EOD page 30, e.g., the EOD validity identifier, as one or more characteristics for analysis. The EOD validity identifier identifies whether EOD page 30 is valid after a write by a cartridge drive to the data cartridge associated with CM chip 20. A cartridge drive writes data to EOD page 30 when the cartridge drive performs a write to the associated data cartridge. Cartridge drives generally record a validity of an EOD page of the CM chip in the EOD page. Generally, the EOD validity identifier is set to a value of “1”, which means that EOD page 30 is valid. During a write to the cartridge drive, the cartridge drive sets the EOD validity to “2”, which means that writing is ongoing. The cartridge drive sets the validity to “1” when writing to the data cartridge has successfully completed. However, when the cartridge drive is unable to successfully complete the write, the cartridge drive sets the validity to “3”, which means “invalid.” During analysis of EOD page 30, e.g., by analysis module 6 (FIG. 1), the EOD validity identifier may be inspected to determine whether the associated data cartridge has encountered an error during writing. In general, when the validity identifier indicates that the EOD page is invalid, analysis module 6 generates information indicating that the health status of the data cartridge is bad, e.g., suggesting further analysis of or replacement of the corresponding data cartridge. When the validity identifier indicates that the EOD page is valid, however, analysis module 6 may inspect other characteristics of data from the CM chip to generate information regarding a health status of the data cartridge.

EOD page 30 also includes a thread count value that corresponds to the number of times the data cartridge has been mounted as of the time that the write that caused EOD page 30 to be written occurred. The thread count value of EOD page 30 may therefore be inspected to determine whether a write has occurred recently, e.g., within the last four mounts of the data cartridge. A “mount” of a data cartridge corresponds to a drive taking action with respect to that data cartridge, e.g., the data cartridge is mounted in the drive and the drive may perform reads, writes or other actions with respect to the data cartridge. When a write has occurred recently, analysis module 6 may examine different characteristics of the data from the CM chip than when a write has not occurred recently. That is, analysis module 6 may modify the analysis performed based on whether or not the data cartridge has experienced a write recently, e.g., within the last four mounts of the data cartridge. If the thread count of EOD page 30 is greater than or equal to the thread count of at least one of usage pages 36, then a write has occurred within the last four mounts of the data cartridge. Accordingly, an analysis module, such as analysis module 6 (FIG. 1) may determine that a write has occurred within the last four mounts when the thread count of EOD page 30 is greater than or equal to the thread count of at least one of usage pages 36, and modify the analysis of the data accordingly, e.g., as described in greater detail below.

An analysis module, such as analysis module 6 (FIG. 1) may also determine whether any of the total error counts of a usage page has increased. The analysis module may compare values for each of the unrecovered read errors, unrecovered write errors, and fatal suspended write errors of a first one of usage pages 36 and a second one of usage pages 36 to determine whether any of these values has increased from the first one of usage pages 36 to the second one of usage pages 36. When at least one of the total error counts of the usage page has increased, analysis module 6 may determine that further analysis is recommended or that the data cartridge is bad. Analysis module 6 generally treats an increasing error count as one of a plurality of characteristics that indicate that a data cartridge is experiencing poor health, among the other example characteristics discussed herein.

In one embodiment, analysis module 6 determines that when a data cartridge has 1) an EOD validity of “valid”, 2) a value for at least one of the unrecognized write errors, unrecognized read errors, and the total suspend write errors in excess of the corresponding threshold, 3) a recent (e.g., within the last four mounts) write operation, and 4) a value for at least one of the unrecognized write errors, unrecognized read errors, and the total suspend write errors that has incremented, the data cartridge has a bad health status or the data cartridge is in need of further analysis. Analysis module 6 may therefore generate information regarding the health status of the data cartridge, e.g., triggering an alert, setting a flag corresponding to the health status of the data cartridge, or other generating other information. In one embodiment, analysis module 6 determines that when a data cartridge has 1) an EOD validity of “valid”, 2) a value for at least one of the unrecognized write errors, unrecognized read errors, and the total suspend write errors in excess of the corresponding threshold, and 3) no recent write operation (e.g., within the last four mounts), the data cartridge has a bad health status or the data cartridge is in need of further analysis. The truth table presented in Table 1 below summarizes these examples.

TABLE 1

| | # Unrecovered | | | |
|---|---|---|---|---|
| | writes > threshold | | | |
| | OR | | | |
| | # unrecovered reads > | | | |
| | threshold | | | |
| | OR | | | Recommend |
| EOD | # fatal suspended | Write | # Errors | further |
| Invalid? | writes > threshold? | operation? | incremented? | analysis? |
| No | Yes | Yes | Yes | Yes |
| No | Yes | Yes | No | No |
| No | Yes | No | X | Yes |
| No | No | X | X | No |
| Yes | X | X | X | Yes |

In another embodiment, rather than recommending further analysis, analysis module 6 may declare that the data cartridge has a bad health status, e.g., by triggering an alert, displaying a message, e-mailing an administrator, or setting a flag in data of CM chip 20. In the example truth table of Table 1, an “X” value indicates that the value may be “yes” or “no” for the associated cell, with the same result in the “recommend further analysis?” column.

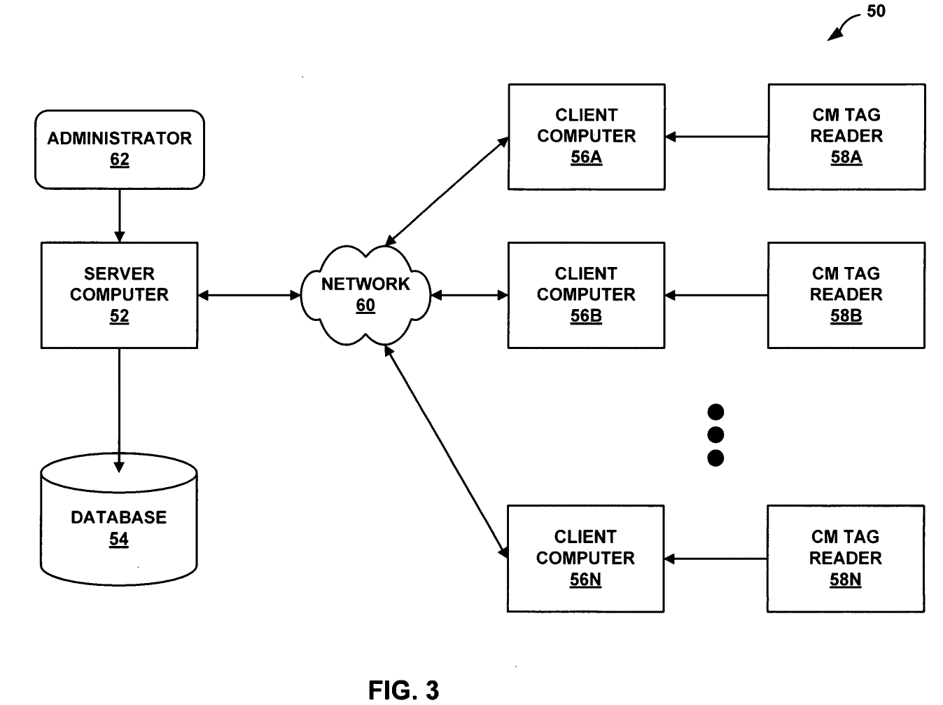

FIG. 3 is a block diagram illustrating an example system 50 that determines characteristics of data cartridges that have a bad health status. In general, client computers 56A-56N (client computers 56) receive CM data from CM tag readers 58A-58N (CM tag readers 58) respectively and upload the received CM data to server computer 52 via network 60. Server computer 52 stores the received CM data in database 54. Server computer 52 may also compare received data to data stored in database 54 to identify characteristics of data cartridges that indicate whether a particular data cartridge has a good or bad health status, as described in greater detail below.

In the example of FIG. 3, server computer 52 is in communication with database 54. In another embodiment, database 54 may be an internal component of server computer 52. In the example of FIG. 3, database 54 includes entries corresponding to data collected from various CM chips of various data cartridges. In general, database 54 stores entries regarding read and write errors of the various CM chips. Server computer 52 may store entries in database 54 based on data read from the CM chips, including data from usage pages, end-of-data pages, and write pass pages. Server computer 52 receives data from client computers 56 and forms the entries for database 54 from this data. Database 54 stores a large number of entries, e.g., between 100,000 and 200,000 entries, each corresponding to a read of a CM chip of a data cartridge.

Database 54 therefore contains entries corresponding to data from a plurality of CM chips of various data cartridges. The entries of database 54 are a set of historical data that include various characteristics of a plurality of data cartridges, as well as whether a particular cartridge has a good health status or a bad health status. The initial setting of a good or bad health status for a particular data cartridge may be configured by an administrator, such as administrator 62, or may be uploaded along with the data from the CM chip. Administrator 62 may also determine other characteristics from the historical data of database 54, such as, for example, progressing performance of a particular cartridge, including servo performance and data performance of the data cartridge. In one embodiment, an entry of database 54 includes usage information from usage pages of the CM chips, EOD information including a cartridge drive serial number associated with the cartridge drive that performed a write to the data cartridge, a total number of mounts of the data cartridge, a current wrap of the data cartridge, a physical location of an end-of-data marker, and when a last write was not a success, a position of the last successful write operation, and a validity of the EOD information.

In one embodiment, an entry of database 54 includes data from one or more usage pages including a number of unrecovered write errors, a number of write retry errors, a number of unrecovered read errors, a number of read retry errors, a number of suspended writes, a number of fatal suspended writes, a number of datasets written, a number of datasets read, and a cumulative cartridge mount. Server computer 52 and/or administrator 62 may identify particular parts of an entry of database 54 that correlates with or otherwise indicates whether a health status of a particular data cartridge is good or bad.

From the historical data and corresponding indices of whether a data cartridge has a good health status or a bad health status, server computer 52 may predict cartridge failure of a particular data cartridge when new data from the CM chip of the data cartridge is received and compared with the historical data. When server computer 52 reads a CM chip of a data cartridge, server computer 52 compares read- and write-error data from the CM chip 14 to the data stored in database 54. Server computer 52 may then determine a health status for the data cartridge based on this comparison. In one embodiment, for example, server computer 52 classifies the data cartridge as new, good, bad, or as being recommended for further analysis. In this manner, server computer 52 may predict failure of data cartridges from data of associated CM chips.

In one embodiment, administrator 62 configures server computer 52, through a user interface of server computer 52, based on data of database 54 to predict failure of data cartridges, based on characteristics of data read from associated CM chips of the data cartridges. Administrator 62 may use server computer 52 to identify failure trends of data cartridges as the data cartridges are scanned and data from CM chips of the data cartridges are stored in database 54. For example, administrator 62 may identify specific error characteristics among data taken from CM chips of data cartridges in database 54 to identify which characteristic or set of characteristics tend to identify a data cartridge that is about to fail, and to distinguish data cartridges that are not near failure.

From the data of database 54, administrator 62 and/or server computer 52 may construct an algorithm for identifying a health status of data cartridges. Administrator 62 may then distribute this algorithm to one or more of client computers 56. Then, when one of client computers 56, e.g., client computer 56A, receives CM data from CM tag reader 58A for a particular data cartridge, client computer 56A may determine a health status of the data cartridge associated with the CM data. In this manner, administrator 62 may build a new algorithm or customize existing algorithms for determining a health status of data cartridges.

In one embodiment, for example, each characteristic of data from CM chips may be used as input for a neural network algorithm executed by server computer 52 that identifies specific characteristics that tend to differentiate data cartridges with a good health status from data cartridges with a bad health status. In another embodiment, administrator 62 may configure server computer 52 to perform statistical analyses to identify such characteristics. In other embodiments, other methods may be used to identify characteristics that differentiate data cartridges with a good health status from data cartridges with a bad health status. Administrator 62 may then develop an algorithm to differentiate data cartridges with a good health status from data cartridges with a bad health status based on these identified characteristics. For example, a truth table similar to that depicted in Table 1 may be developed using these or similar techniques.

Administrator 62 may also configure server computer 52 to analyze other characteristics of a client's cartridge management system, which may include data cartridges, one or more cartridge drives, a cartridge storage facility, or other elements. For example, when a particular client possesses a plurality of cartridge drives, server computer 52 may analyze data of database 54 to identify particular cartridge drives from which data cartridges receive statistically more read- or write-errors than other cartridge drives of the client. When such a drive exists, server computer 52 may generate information regarding a health status of the cartridge drive. For example, server computer 52 may identify the cartridge drive as a faulty cartridge drive, rather than identifying the data cartridges as having a bad health status. Server computer 52 may then send the identification of the faulty cartridge drive to the client, so that the client may repair or replace the cartridge drive.

As another example, administrator 62 may configure server computer 52 to identify a high number of errors occurring near the edge of the tape of a data cartridge for a plurality of data cartridges for a particular client. When errors systematically occur near the edge of the tape for a plurality of data cartridges, server computer 52 may determine that the affiliated client has a cartridge handling problem, e.g., that the cartridges have been dropped by employees or by robotic actuator arms that move the cartridges are malfunctioning. In this case, the client may be advised to train employees on cartridge handling or repair or replace a malfunctioning robotic actuator arm to prevent dropping of the cartridges.

As another example, administrator 62 may configure server computer 52 to identify a client data cartridge usage profile and to compare the client data cartridge usage profile to an average industry usage profile. Administrator 62 may further configure server computer 52 to provide usage modification recommendations. For example, a particular client may mount certain cartridges more often than the average for the industry and may write less data per mount to the cartridge. Server computer 52 may identify such a scenario and recommend mounting the data cartridges less frequently, while writing more data per mount to the data cartridges to extend the life of the data cartridges for the client. Server computer 52 may, for example, generate a report that is sent to users of the data cartridges with this recommendation. Users of server computer 52 may also inspect the recommendation from server computer 52 and explain the recommendation to the users of the data cartridges.

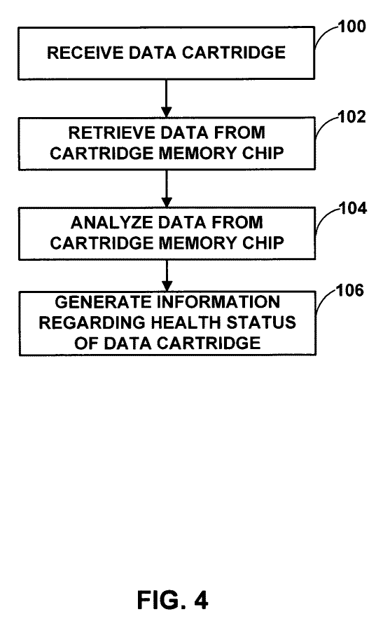

FIG. 4 is a flowchart illustrating an example method for predicting failure of a data cartridge based on data stored on a CM chip of the data cartridge. Although discussed with respect to the example system of FIG. 1, it should be understood that any device or system may perform the method of FIG. 4.

Initially, CM tag reader 16 receives data cartridge 12 (100), e.g., data cartridge 12 comes into close proximity of CM tag reader 16, such as within 20 mm or closer. For example, data cartridge 12 may be inserted into a cartridge drive that includes a CM tag reader. As another example, data cartridge 12 may be scanned by a CM tag reader.

CM tag reader 16 then retrieves data from CM chip 14 of data cartridge 12 (102). For example, CM chip 14 may be an RFID tag, and CM tag reader 16 may be an RFID reader that retrieves data over a radio frequency signal sent by CM chip 14. CM tag reader 16 may send a signal to provide power to CM chip 14. In any case, CM tag reader 16 reads CM chip 14 to retrieve data from CM chip 14. The data may include, for example, particular pages of CM chip 14 or specific information from particular pages of CM chip 14.

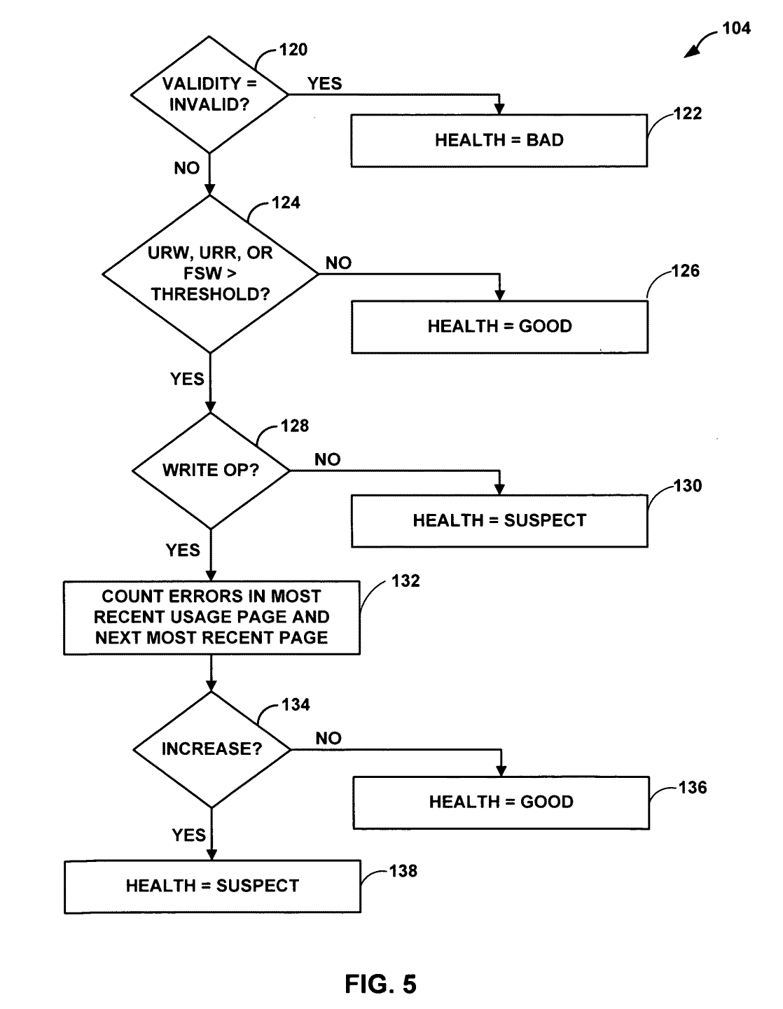

CM tag reader 16 passes the retrieved data to computing device 10. Analysis module 6 of computing device 10 analyzes the data (104) and generates information regarding a health status of data cartridge 12 based on the analysis (106). An example method for analyzing the data is discussed with respect to FIG. 5, below. In one embodiment, analysis module 6 outputs the generated information to a user, e.g., via a user interface such as a graphical user interface of computing device 10. In another embodiment, analysis module 6 sets a flag of CM chip 14 corresponding to the health status of data cartridge 12. For example, one bit of CM chip 14 may be a status flag bit, and analysis module 6 may set the bit to “0” when data cartridge 12 has a “good” health status, and analysis module 6 may set the bit to “1” when data cartridge 12 has a “bad” health status. In another embodiment, analysis module 6 transmits the generated information over a network to another computing device.

FIG. 5 is a flowchart illustrating an example method for analyzing data of CM chip 14. In the example of FIG. 5, the method corresponds to step 104 of the method of FIG. 4. It should be understood, however, that other methods may be used to analyze data retrieved from CM chips, from which health status information may be generated. Likewise, although discussed with respect to the example of FIG. 1, it should be understood that other devices may implement the method of FIG. 5. In one embodiment, the method of FIG. 5 may be developed by a server computer after analyzing data from CM chips of a plurality of data cartridges collected in a database. An administrator may also develop or refine a method developed by the server computer to produce the method of FIG. 5 or other similar methods for analyzing data of CM chip 14.

In the example of FIG. 5, analysis module 6 first determines whether an EOD page of CM chip 14 is valid (120) by checking an EOD validity identifier of the EOD page. As an example, a value of “3” of the EOD validity identifier may be used to indicate that the EOD page is invalid. When the EOD validity identifier indicates that the EOD page is invalid (“YES” branch of 120), e.g., when the value of the EOD validity identifier is “3”, analysis module 6 determines that the EOD page of CM chip 14 is invalid, and consequently, that the health of data cartridge 12 is bad (122).

When the EOD validity identifier indicates that the EOD page of CM chip 14 is valid, (“NO” branch of 120), analysis module 6 next checks various error thresholds to determine if any of the error thresholds have been exceeded (124). In the example of FIG. 5, analysis module 6 checks the total value of unrecovered writes (URW) against an unrecovered writes threshold, the total value of unrecovered reads (URR) against an unrecovered reads threshold, and the total value of fatal suspended writes (FSW) against a fatal suspended writes threshold. For example, the unrecovered writes threshold may be “10,” the unrecovered reads threshold may be “10,” and the fatal suspended writes threshold may be “1.” The threshold may be dependent upon a manufacturer of the drive. When none of these thresholds have been exceeded (“NO” branch of 124), analysis module 6 determines that the health of data cartridge 12 is good (126).

When at least one of the thresholds has been exceeded (“YES” branch of 124), analysis module 6 determines whether a write operation has been performed recently (128), e.g., within the last four mounts of data cartridge 12. In order to determine whether a write operation has occurred recently, analysis module 6 may compare the thread count of the EOD page to each thread count of each usage page of CM chip 14. When the thread count of the EOD page is greater than or equal to at least one of the thread counts of the usage pages, analysis module 6 determines that a write operation has occurred recently, and when the thread count of the EOD page is less than all of the thread counts of the usage pages, analysis module 6 determines that no write operation has occurred recently.

When no write operation has occurred recently (“NO” branch of 128), analysis module 6 determines that the health status of data cartridge 12 is suspect (130), e.g., that data cartridge 12 has a bad health status and needs replacement, or that further inspection of data cartridge 12 is necessary. Analysis module 6 may further examine data cartridge 12 to determine whether data cartridge 12 is under warranty. When analysis module 6 determines that data cartridge 12 is no longer covered by a warranty, analysis module 6 may state that data cartridge 12 should be replaced, but when data cartridge 12 is covered by a warranty, analysis module 6 may determine that further inspection is necessary. Analysis module 6 may further determine whether data cartridge 12 is a particular brand or vendor specific, and identify the health status of data cartridge 12 based on the identification of the vendor specific or brand determination. For example, for a native brand, analysis module 6 may determine that further analysis is necessary, but for a competitive brand, analysis module 6 may recommend replacement of data cartridge 12.

When a write operation has occurred recently (“YES” branch of 128), analysis module 6 checks for an increase in the number of errors in data cartridge 12 at the most recent mount. Initially, analysis module 6 identifies the most recent mount and next-to-most recent mount of data cartridge 12 by identifying the two highest-valued thread counts of the usage pages of CM chip 14. Analysis module 6 then identifies the total number of errors of unrecovered writes, unrecovered reads, and fatal suspended writes for both the most recent and next-to-most recent mounts of data cartridge 12 (132). When there is no increase in the total number of errors (“NO” branch of 134), analysis module 6 determines that the health status of data cartridge 12 is good (136). However, when there has been an increase in the total number of errors (“YES” branch of 134), analysis module 6 determines that the health status of data cartridge 12 is suspect (138), similarly to (130).

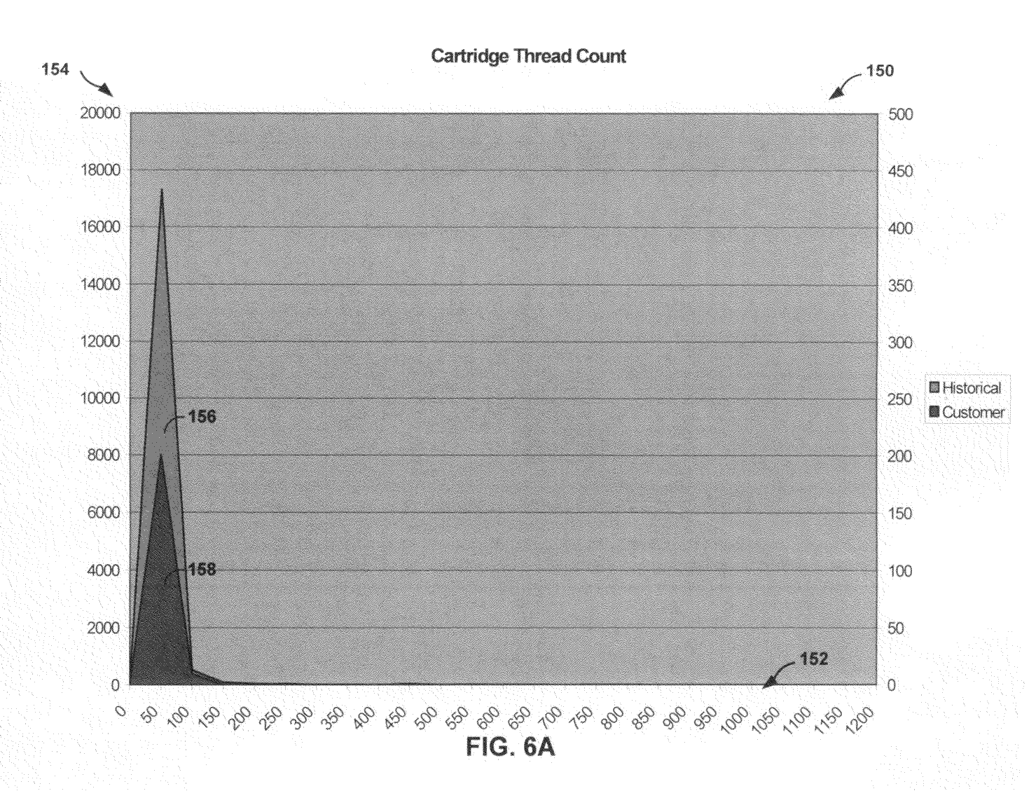

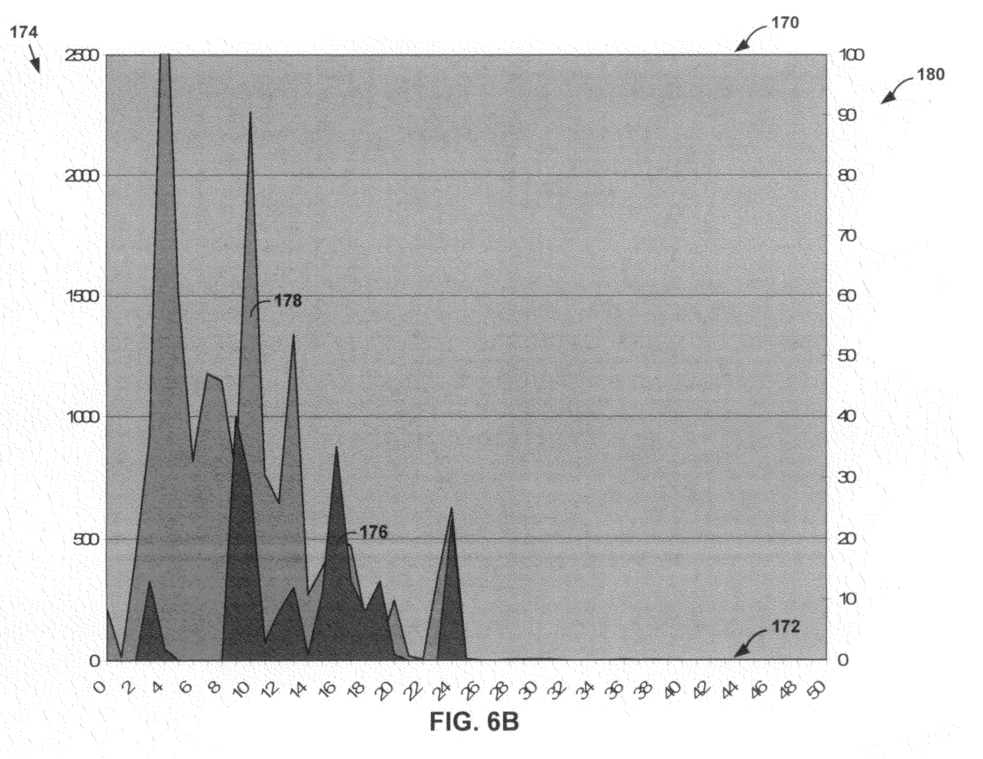

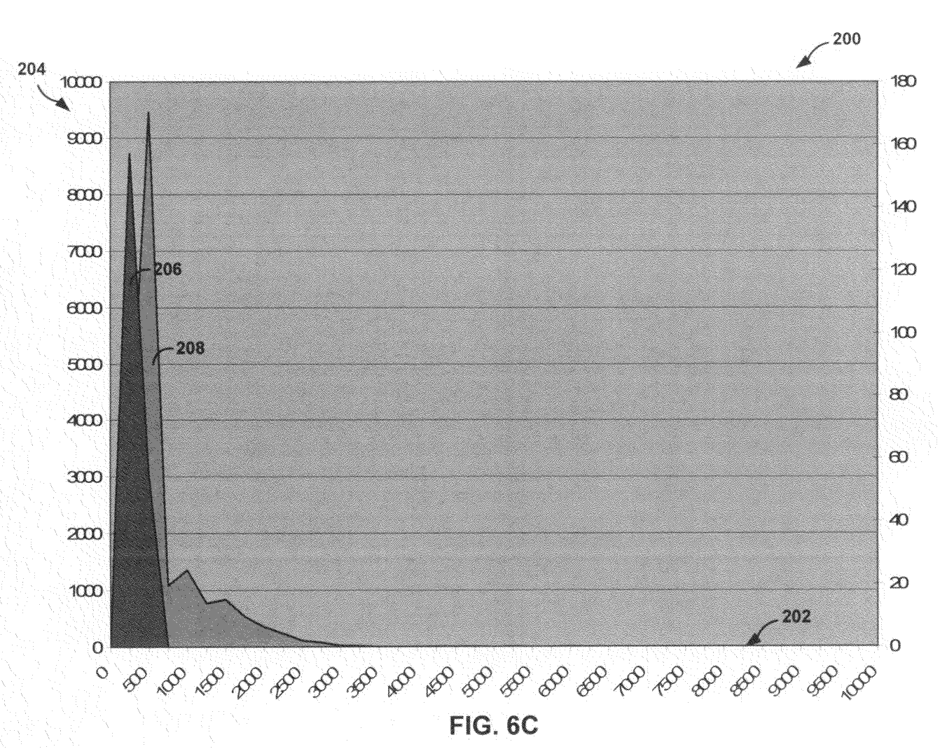

FIGS. 6A-6C are graphs illustrating example data collected from data cartridges of an example client and compared with industry average data. FIG. 6A depicts graph 150 that compares a number of mounts per cartridge (x-axis 152) to a number of cartridges used (y-axis 154) for a specific client (region 158) and for a plurality of customers as a global average (region 156). FIG. 6B depicts graph 170 that compares a cartridge age in months (x-axis 172) to a number of historical cartridges (y-axis 174) for a plurality of customers as a global average (region 178) and to a number of customer cartridges (y-axis 180) for a specific client (region 176). FIG. 6C depicts graph 200 that compares an amount of data of data cartridges used in gigabytes (x-axis 202) to a number of cartridges (y-axis 204) for a specific client (region 206) and a plurality of customers as a global average (region 208).

FIGS. 6A-6C collectively demonstrate that the example client has fewer cartridges than average, that the cartridges in the client's inventory are older, on average, and that the client writes less data than average to the cartridges per mount. The client may send usage data to server computer 52 (FIG. 3) using one of client computers 56. Server computer 52 may output the graphs of FIGS. 6A-6C and transmit the graphs to the client via network 10. The client may then change data cartridge utilization practices to maximize the life of the cartridges. The client may also optimize the number of cartridges in the client's inventory to obtain better utilization of the data cartridges.

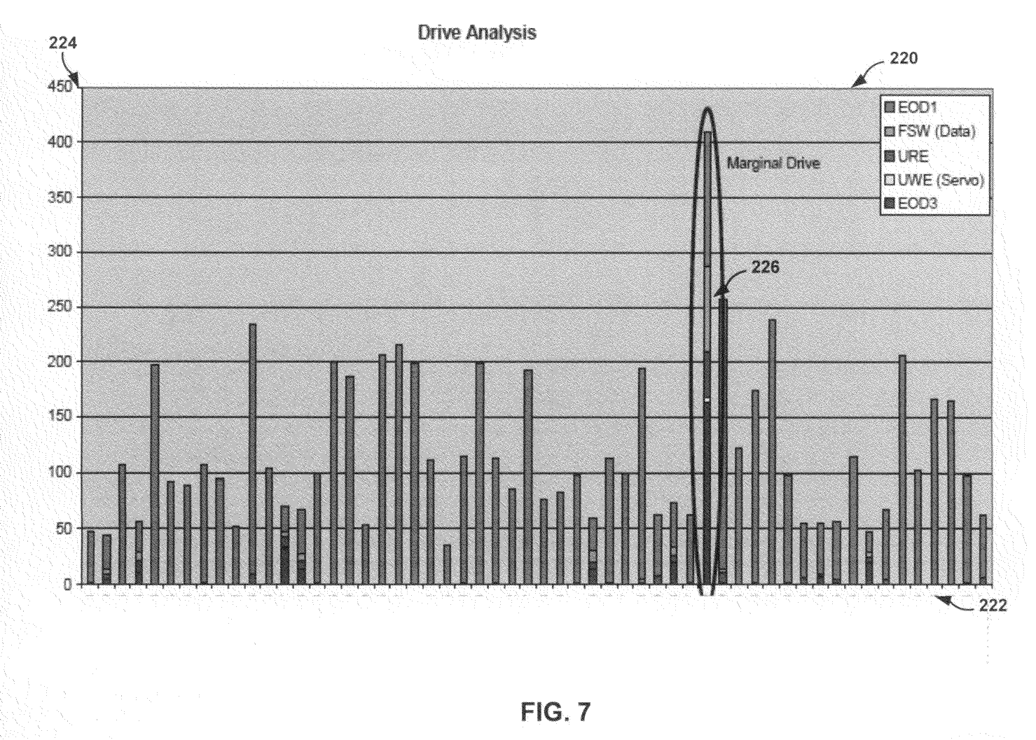

FIG. 7 is a graph illustrating example data collected from data cartridges of a client to identify a malfunctioning cartridge drive. Graph 220 depicts various statistics of individual cartridge drives, listed by serial number (x-axis 222). In the example graph of FIG. 7, the statistics include an EOD validity that is “valid”, a number of fatal suspended writes, a number of unrecovered read errors, a number of unrecovered write errors, and an end-of data validity that is “invalid.” The total for these statistics is displayed by drive in the y-axis direction 224, which identifies the total number by cartridge drive. By comparing the totals for each cartridge drive, server computer 52 may identify an average among the cartridge drives for each statistic, or a total for the statistics by drive. In the example of FIG. 7, cartridge drive 226 has many more errors than any of the other cartridge drives depicted in graph 220. Therefore, server computer 52 may identify cartridge drive 226 as requiring repair or replacement. Server computer 52 may further identify drives read and/or written to by cartridge drive 226 and determine that their respective health statuses should be set to “good”, if they were set to “bad” after having been mounted by cartridge drive 226.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described herein may also be embodied in a computer readable medium containing instructions. Instructions embedded in a computer readable medium may cause a processor to perform the method, e.g., when the instructions are executed. Computer readable storage media, for example, may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various embodiments of the invention have been described. These and other embodiments are within the scope of the following claims.

1. A system comprising:
a chip reader that retrieves data from a cartridge memory chip of a data cartridge; and
a computing device that receives the data from the chip reader, analyzes the data, and generates information regarding a health status of the data cartridge based on the analysis.

2. The system of claim 1, wherein the computing device analyzes the data to determine whether an end-of-data validity identifier of the data retrieved from the cartridge memory chip identifies the validity of a corresponding end-of-data page as invalid.

3. The system of claim 1, wherein the computing device analyzes the data to determine whether a count of unrecovered write errors of the data retrieved from the cartridge memory chip exceeds an unrecovered write error threshold.

4. The system of claim 1, wherein the computing device analyzes the data to determine whether a count of unrecovered read errors of the data retrieved from the cartridge memory chip exceeds an unrecovered read error threshold.

5. The system of claim 1, wherein the computing device analyzes the data to determine whether a count of fatal suspended write errors of the data retrieved from the cartridge memory chip exceeds a fatal suspended write error threshold.

6. The system of claim 1, wherein the computing device analyzes the data to determine whether a write operation occurred on the data cartridge from the data retrieved from the cartridge memory chip.

7. The system of claim 1, wherein the computing device analyzes the data to determine whether a total error count of a most recent usage information page of the data retrieved from the cartridge memory chip is greater than a total error count of a next most recent usage information page of the data retrieved from the cartridge memory chip.

8. The system of claim 1, wherein the computing device generates the information to reflect that the health status of the data cartridge is bad when the analysis of the data indicates that an end-of-data validity identifier of the data retrieved from the cartridge memory chip identifies the validity of a corresponding end-of-data page as valid, at least one of a count of unrecovered write errors, a count of unrecovered read errors, and a fatal suspended write errors of the data retrieved from the cartridge memory chip exceeds a corresponding threshold, a write operation occurred in at least one mount of the data cartridge as recorded in the data retrieved from the cartridge memory chip, and a total number of errors increased at the time of the at least one mount.

9. The system of claim 1, wherein the computing device generates the information to reflect that the health status of the data cartridge is bad when the analysis of the data indicates that an end-of-data validity identifier of the data retrieved from the cartridge memory chip identifies the validity of a corresponding end-of-data page as valid, at least one of a count of unrecovered write errors, a count of unrecovered read errors, and a fatal suspended write errors of the data retrieved from the cartridge memory chip exceeds a corresponding threshold, and a write operation has not occurred in any mount of the data cartridge as recorded in the data retrieved from the cartridge memory chip.

10. The system of claim 1, wherein the computing device receives executable instructions for analyzing the data from a server computing device.

11. A method comprising:
retrieving data from a cartridge memory chip of a data cartridge:
analyzing the data from the cartridge memory chip; and
generating information regarding a health status of the data cartridge based on the analysis of the data.

12. The method of claim 11, wherein retrieving data comprises retrieving a value for unrecovered reads, a value for unrecovered writes, and a value for fatal suspended writes from the cartridge memory chip.

13. The method of claim 12, wherein analyzing the data comprises determining whether at least one of the value for the unrecovered reads exceeds an unrecovered reads threshold, the value for unrecovered writes exceeds an unrecovered writes threshold, and the value for fatal suspended writes exceeds a fatal suspended writes threshold.

14. The method of claim 11,
wherein retrieving comprises retrieving a thread count from an end-of-data page of the cartridge memory chip and a thread count for each of a plurality of usage pages of the cartridge memory chip, and
wherein analyzing the data comprises determining whether the thread count from the end-of-data page is equal to or exceeds at least one of the thread counts for the plurality of usage pages to determine whether a write operation has occurred recently on the data cartridge.

15. The method of claim 11, wherein analyzing the data comprises:
identifying a first value corresponding to a number of errors for a most recent usage page of the cartridge memory chip;
identifying a second value corresponding to a number of errors for a next-most-recent usage page of the cartridge memory chip; and
determining whether the first value is greater than the second value.

16. A system comprising:
a database that stores entries from a plurality of cartridge memory chips, wherein each of the cartridge memory chips is associated with a respective data cartridge;
a server computer that stores the entries in the database; and
a plurality of client computers that retrieve data from the plurality of cartridge memory chips and send at least a portion of the retrieved data to the server computer,
wherein the server computer forms the entries for the database from the at least portion of data received from the client computers, and
wherein the server computer analyzes the entries stored in the database and generates information regarding a health status of at least one of the data cartridges based on the analysis.

17. The system of claim 16, wherein the server computer generates an algorithm for differentiating data cartridges that have a good health status from data cartridges that have a bad health status based on the analysis and sends the algorithm to at least one of the plurality of client computers.

18. The system of claim 16, wherein the server computer generates information regarding a health status of a cartridge drive associated with at least one of the plurality of client computers based on the analysis, wherein the entries in the database indicate that the cartridge drive has mounted at least one of the data cartridges associated with one of the plurality of cartridge memory chips.

19. The system of claim 16, wherein the server computer sends the generated information to at least one of the plurality of client computers.

20. The system of claim 16, wherein the server computer further comprises a user interface, wherein the server computer receives a configuration from a user through the user interface and generates the information based on the configuration.
